(19) United States
(12) Patent Application Publication
(10) Pub. No.: US 2015/0070812 A1
(43) Pub. Date: Mar. 12, 2015

(54) SOLAR POWERED PLANT IONIZER

(71) Applicant: Jimmy Luther Lee, Penngrove, CA (US)

(72) Inventor: Jimmy Luther Lee, Penngrove, CA (US)

(21) Appl. No.: 14/485,321

(22) Filed: Sep. 12, 2014

Related U.S. Application Data
(60) Provisional application No. 61/877,048, filed on Sep. 12, 2013.

(51) Int. Cl. A01G 7/04; A01G 1/00; H01T 23/00

(52) U.S. Cl. CPC A01G 7/04; H01T 23/00; A01G 1/001
USPC 361/231

(57) ABSTRACT

An air ionizing apparatus for enhancing plant growth that includes a housing, solar cells mounted atop the housing, a voltage regulator/conditioner circuit coupled to the solar cells, an oscillator/modulator circuit coupled to the voltage regulator/conditioner circuit, a high voltage converter/multiplier circuit coupled to the oscillator/modulator circuit, and an ion emitter element coupled to the high/voltage converter/multiplier circuit and disposed at the bottom of the housing. Solar energy transferred to the solar cells and converted into current is converted to high voltage through the voltage/regulator, oscillator/modulator, and high voltage converter/multiplier circuits. The high voltage is then applied to the ion emitter element to produce ions from ambient air in close proximity to a plant being treated.

### CROSS-REFERENCES TO RELATED APPLICATIONS

The instant application claims the benefit of the filing date of U.S. Provisional Patent Application 61/877,048, filed Sep. 12, 2013 (Sep. 12, 2013), which application is incorporated in its entirety by reference herein.

### STATEMENT REGARDING FEDERALLY SPONSORED RESEARCH OR DEVELOPMENT

Not applicable.

### THE NAMES OR PARTIES TO A JOINT RESEARCH AGREEMENT

Not applicable.

### INCORPORATION BY REFERENCE OF MATERIAL SUBMITTED ON A COMPACT DISC

Not applicable.

### BACKGROUND INFORMATION AND DISCUSSION OF RELATED ART

1. Field of the Invention

The present invention relates generally to air ionizing devices, and more particularly an air ionizing method and apparatus for enhancing and accelerating plant metabolism and growth, and still more particularly to a negative ion converter/generator that enhances the growth and health of land-based plants.

2. Description of Related Art Including Information Disclosed Under 37 CFR 1.97 and 37 Cfr 1.98

Land-based plants rely upon light, water, and carbon dioxide to affect the process of photosynthesis to convert carbon dioxide into organic compounds, particularly sugars. Photosynthesis can occur in different ways in different species but most features are always the same. The primary rate of photosynthesis will vary dependent upon light intensity, wavelength, carbon dioxide concentration, and temperature. A less recognized additional component, atmospheric ionization, also greatly affects this process. Extensive research using sugar cane, barley, vegetables and grapes has demonstrated that plant exposure to an ionized (charged) atmosphere also affects the metabolic rate of plant growth and health. While both positive and negative atmospheric ions appear to have a beneficial effect upon plant growth, most studies have concluded that negatively charged atmospheric ions perform better over a much broader spectrum of plant species. Negatively ionized (charged) carbon dioxide molecules are more readily absorbed by plants during photosynthesis thus increasing the photo-induced charge separation process which shuttles electrons through an electron transport chain within the organism. The result is faster growth, more abundant flora or fruit, and a healthier plant.

Until recently the application of manufactured atmospheric ionization relied upon complex and expensive electronic systems which are maintenance intensive and require an external power source. With the instant invention, the energy power source is photons from the sun. A built in solar panel converts the photons, through a sophisticated electronic circuit, to ions for the plant during daylight hours which coincides with the natural photosynthesis periods for the plants. The resulting molecules of atmospheric ions are then available to compliment the photosynthesis process as well as plant respiration and absorption of water and minerals in the soil. The mild electrical charge placed upon the plant by the high voltage ion source also helps to mitigate infestation by unwanted herbivores.

### BRIEF SUMMARY OF THE INVENTION

The present invention is a solar powered air ionizer for enhancing plant metabolism. The inventive apparatus includes, in its most essential aspect, includes a sealed and watertight housing, a solar cell array disposed atop the housing, and circuitry disposed inside the housing for converting current generated by the solar cells into a pulsed high voltage discharged through an ion emitter. The circuitry includes a voltage regulator/converter circuit, an oscillator/modulator, a high voltage converter/multiplier, an ion emitter array, a photocell for switching the device off at night or in low light conditions, a light-emitting status indicator, an alternating current to direct current (AC/DC) wall adapter, and a hanger. The housing is positioned above a plant and the solar cells are exposed to sunlight so that the electrical current thereby generated powers the electronic circuitry. Low voltage DC is converted to pulsed high voltage or high voltage DC, which is then routed through a resistor connected to a high emissivity material having a tip which imparts an electrical charge to nearby atmospheric gas molecules. The plant takes up the charged gases as part of its respiration and metabolic cycles.

Other novel features which are characteristic of the invention, as to organization and method of operation, together with further objects and advantages thereof will be better understood from the following description considered in connection with the accompanying drawing, in which preferred embodiments of the invention are illustrated by way of example. It is to be expressly understood, however, that the drawing is for illustration and description only and is not intended as a definition of the limits of the invention. The various features of novelty which characterize the invention are pointed out with particularity in the claims annexed to and forming part of this disclosure. The invention resides not in any one of these features taken alone, but rather in the particular combination of all of its structures for the functions specified.

### BRIEF DESCRIPTION OF SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is a perspective view of a solar-powered plant ionizer in use according to an exemplary embodiment of the present invention;

FIG. 2 is a block diagram of the solar powered plant ionizer of FIG.1;

FIG. 3 is a schematic view illustrating the low-to-high voltage conversion circuit used in the solar-powered plant ionizer of FIG. 1; and

FIG. 4 is an alternative schematic of a preferred embodiment of the electronic circuit for converting low voltage DC into high voltage pulses.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention generally provides a solar-powered device that generates an ionized atmosphere above a plant. Conversion of solar energy (photons) from low voltage direct current (DC) to a high enough DC pulse voltage or to high voltage DC causes ionization of ambient molecules of oxygen, nitrogen, carbon dioxide, and helium. The charged atmospheric molecules are then absorbed by the plant and increase biological activity, such as increased iron intake during plant respiration.

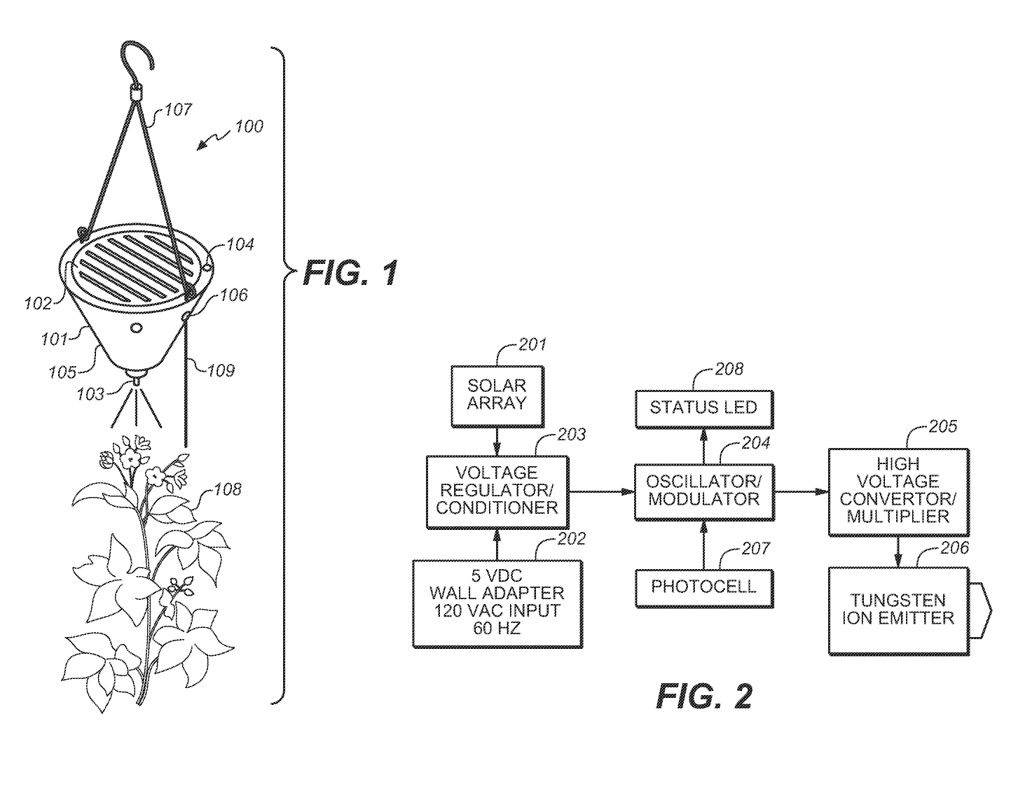

Referring to FIG. 1, the inventive device 100 may include a plastic housing 101 (typically, a watertight sealed assembly measuring about 2″×2″×4″), a solar cell array 102 mounted on top of the housing, a voltage regulator/converter circuit (see FIGS. 2-4), an oscillator/modulator (see FIGS. 2-4), a high voltage converter/multiplier, an ion emitter array 103, a photocell 104 for switching the device off during nighttime, a light-emitting status indicator 105, an alternating current to direct current (AC to DC) wall adapter 106 for indoor use, and a plant hanger and wire 107 for mounting the device above a plant 108 being treated.

Referring next to FIG. 2, the functional elements of the inventive apparatus (shown in block diagrammatic form) include a solar cell array 201, which serves as the primary voltage source to the circuit by converting sunlight to produce a DC voltage typically between 3 VDC and 6 VDC, up to 300 ma. Alternatively, the voltage source may be provided during indoor use by standard 120 VAC to 3 VDC-6 VDC wall adapter 202. The selected voltage source drives voltage regulator/conditioner circuit 203 which, in turn, provides the primary low voltage DC for use by the entire electronic circuit assembly.

Oscillator/modulator 204 receives the low voltage DC, and uses it to generate a high frequency source voltage into the input of high voltage convertor/multiplier circuit 205. High voltage convertor/multiplier circuit 205 converts low voltage high frequency energy into a high voltage of 4 kVDC to 9 kVDC in either positive or negative polarity. The high voltage is connected to ion emitter element 206 (in this example, a tungsten wire). The high voltage may then make contact with ambient air molecules via corona discharge and either extracts or contributes electrons to the air molecules and renders them either positive (cationic) or negative (anionic). The plants respond to the charged (ionized) molecules during respiration, resulting in increased biological activity. Photocell 207 is optional, and when included, if no external light source is available, it turns oscillator/modulator 204 off (eliminating the input to high voltage convertor/multiplier circuit 205, and thereby shutting off the coronal discharge). Solar cell array 201 may also perform the function of photocell 207 by providing sufficiently low voltage output when solar cell array 201 is in such darkness or near darkness that oscillator/modulator 204 cannot function (again, eliminating the input to high voltage convertor/multiplier circuit 205, and thereby shutting off the coronal discharge). An indicator, LED 208, is optionally provided to confirm unit operation when exposed to a sufficiently high intensity light source or when low voltage DC is provided by a connected wall adapter power source.

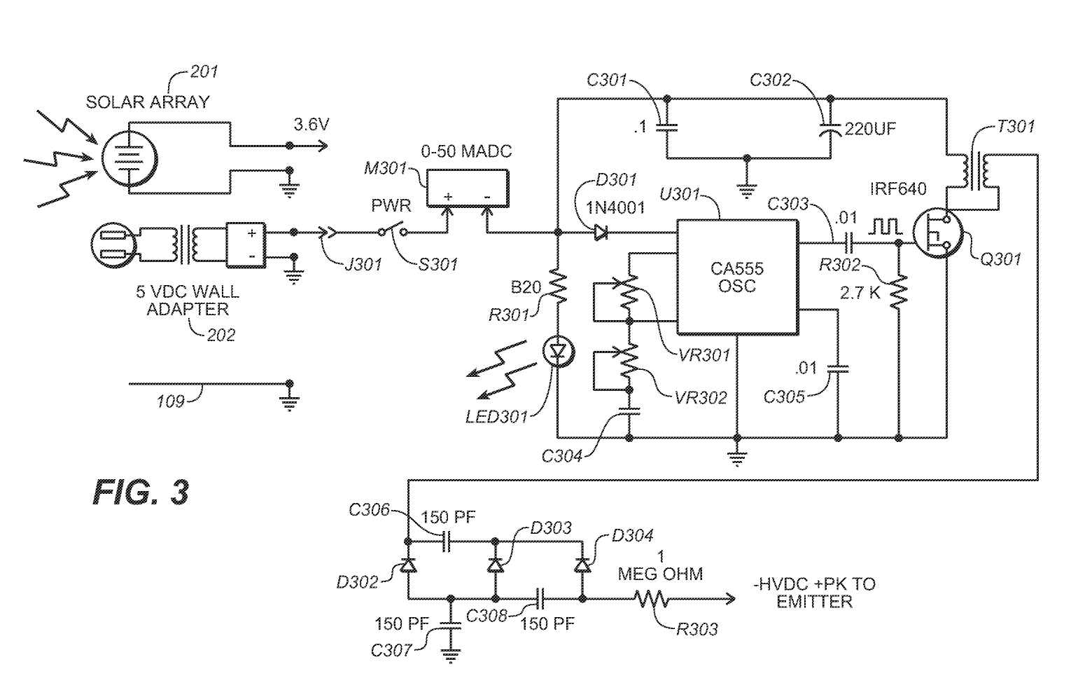

Referring now to FIG. 3, a schematic drawing is shown of a preferred embodiment of the electronic circuit for converting low voltage DC into high voltage for creating a coronal discharge that ionizes nearby air molecules. In FIG. 3, it can be seen that either solar cell array 201 or standard 120 VAC to 3 VDC-6 VDC wall adapter 202 can be connected to power input jack J301 of the circuit.

Input jack J301 passes the low voltage DC to the input side of power on-off switch S301. The output side of switch S301 (when closed) passes the low voltage DC through ammeter M301. After passing through ammeter M301, the low voltage DC is distributed as follows:

Via current-limiting resistor 8301 to light emitting diode LED301 (light emitting diode LED301 provides an indication that the low voltage DC power is applied to the circuit).

Via diode D301 to provide power to integrated circuit oscillator U301.

Via the primary winding of transformer T301 to provide power to the drain terminal of power MOSFET Q301.

Capacitors C301 and C302 operate in parallel to filter noise from the low voltage DC line.

The oscillation frequency of integrated circuit oscillator U301 is determined by the adjustment settings of variable resistors VR301 and VR302 along with the value of capacitor C304. Capacitor C305 is configured to keep integrated circuit oscillator U301 in a continuous state of oscillation whenever the low voltage DC is present.

The oscillating output signal from integrated circuit oscillator U301 is passed through DC isolation capacitor C303, and into the gate of power MOSFET Q301. Resistor R302 provides a biasing voltage at the gate of power MOSFET Q301. Power MOSFET Q301 amplifies the signal provided at its input gate, drawing current through the primary winding of transformer T301. This signal is inductively coupled to the secondary windings of transformer T301, which passes the current into the voltage multiplier circuit comprised of diodes D302, D303 and D304 along with capacitors C306, C307 and C308. Resistor 8303 passes the high voltage output of the voltage multiplier circuit to the ion emitter element 206 (seen in FIG. 2).

When the plant ionizer is powered by the solar cell array, ion output can be increased to levels equivalent to those produced when operated from the wall adapter power source. This is accomplished by connecting the photovoltaic array to the same ground return as the electronic circuit, and additionally connecting a small gauge external wire tendril 109 of approximately 55 centimeters in length to the common ground via the AC/DC adapter. The wire dangles from the jack for the wall adapter 106 on the outside of housing 101, where it is exposed to the atmosphere and may make direct contact with the plant or with an earth ground. It reduces space charge built up within and around the electronic drive circuitry and broadens the electric field around the device to aid in propagating the ions into an expanded coverage area.

Space charges commonly occur near a high voltage connection points when gas near the connection point undergoes dielectric breakdown, and electrical charges are thereby injected into the region near the point forming space charge regions in the surrounding gas. Trapped space charges within dielectrics are a contributing factor in dielectric failure and reverse biasing of solid state electronic components. Due to the high voltage generated by the inventive circuit assembly inside the plant ionizer housing (FIG. 3), electric charge potentials exceeding 10 kV exist within the volume of air and coating materials encapsulating the circuit assembly. The high voltage charge potentials confined to a small area and minimal dielectric form space charges which inhibit high voltage multiplier operation and pulse drive sources within the circuit. The result is reduced high voltage output to the tungsten emitter, which reduces the level of ion production when the emitter is exposed to the atmosphere.

Furthermore, the electric field gradient that serves to propagate (distribute) produced ions over a broader area is limited by reduced voltage and the relatively small size of the plant ionizer internal ground plane. Accordingly, an extension of the high voltage circuit ground plane acts to extend the generated field while simultaneously bleeding the space charge to an external source existing in the immediate area of the device, such as earth ground or, more commonly, the atmosphere to earth dielectric.

The solar powered system will then operate similarly to when operated with an external DC power source, such as a wall adapter, which performs a similar function via it's hard wired ground connection to the plant ionizer circuitry.

To incorporate this feature into the plant ionizer, a very small gauge stainless steel stranded wire (28 ga) of approximately 55 centimeters in length, is connected to the ground side only of a female power plug. This very flexible and strong conductor is then plugged into the existing male plant ionizer power jack, available when operating from a solar power voltage source and not from an external (wall adapter) 5 VDC source. The result is that the circuit ground plane from the solar array as well as the drive circuit assembly is extended into the atmosphere surrounding the plant ionizer. The length of 55 cm was selected as the optimum length based upon maximum ion production available at drive voltage potentials in a range of −8 kV DC to −12 kV DC delivered to the tungsten emitter. Many variations of the bleed source wire tendril are possible including a reconfiguration the housing assembly to something larger and electrically conductive.

Typical ion production measured 6 inches from the emitter without this feature was approximately 1,000,000 ions per cm³ per second. Ion production measured 6 inches from the emitter with this feature increased to levels greater than 10,000,000 ions per cm³ per second.

In an exemplary use, the article of the present invention operates by being positioned above a plant and having the upwardly facing solar cell array 201 on the top surface of the housing exposed to sunlight. Solar energy is converted to electrical energy by the solar cells. The electrical energy then powers the electronic circuit, which converts low voltage DC to pulsed high voltage or high voltage DC. The high voltage may be routed through a current limiting resistor and then connected to a high emissivity material, such as pure tungsten wire having a sharp tip to impart an electrical charge to nearby atmospheric gas molecules. The plant may become mildly charged by virtue of the proximity to the ionizing high voltage source. A noticeable reduction in the presence of herbivores, such as ants, aphids, and ladybugs, has been observed on ionized plants, as compared to non-ionized plants.

An alternative and/or additional use of the device is to freshen the breathable air in which humans and animals dwell. Negatively ionized air may be beneficial to animals for a variety of reasons.

Negative ionization of atmospheric molecules is the desired goal because it has been determined that most plants respond favorably to this polarity. Atmospheric ionization at sea level may occur at a minimum of approximately 3.5 kV, and the circuit may provide 4 kV in most instances, even at dawn and dusk. The circuit may increase available high voltage as the sun peaks through a daily cycle to produce as much as 9 kV during peak sunlight hours, which is concurrent with peak photosynthesis for most plants.

Standard miniature solar panel arrays, such as those used in solar powered landscape lighting, may be used to drive an electronic circuit designed to step up the voltage to a high enough level to ionize air molecules. The ionized air molecules may then be placed near virtually any plant to improve metabolic activity in the plant, resulting in healthier, faster growth, and an increased yield in flowers, vegetables, or fruit.

The solar cells may be replaced with an external source of power such as batteries, AC line voltage, or a HVDC trunk line connected to one or many emitter assemblies. While not very practical, alternate power sourcing schemes may be used, particularly when the plants to be treated are grown indoors. It should be understood that the foregoing relates to exemplary embodiments of the invention and that modifications may be made without departing from the spirit and scope of the invention as set forth in the following claims.

For maximum effectiveness, the air ionizer is placed 9 to 12 inches above the plants receiving treatment. It is raised periodically as the plants grow to maintain this distance. The effective treatment range of a single air ionizer is approximately three square feet from the center of the unit. Care should be taken not to allow the emitter located at the bottom of the air ionizer to come into direct contact with anything but the air around the plant. The unit begins operation as soon as it is exposed to sunlight, which may be confirmed by observing a flashing green LED light on the side of the unit. The frequency and intensity of the flashing green LED varies depending upon the intensity of the absorbed sunlight. The air ionizer should be positioned to maximize its exposure to sunlight.

At the center bottom of the air ionizer is a single tungsten emitter. This is the high voltage discharge point of the device and is responsible for ionizing surrounding air molecules by contributing one or more electrons to them. Touching the emitter will not harm the unit, but a user may feel a slight electrical shock, much like the shock from static discharge when touching a door handle after walking on carpet. Thus, it should be avoided. While this is a non-lethal voltage source, designed to shut off immediately upon contact with anything other than air, care should be taken not to touch the emitter or to allow it to touch the plant.

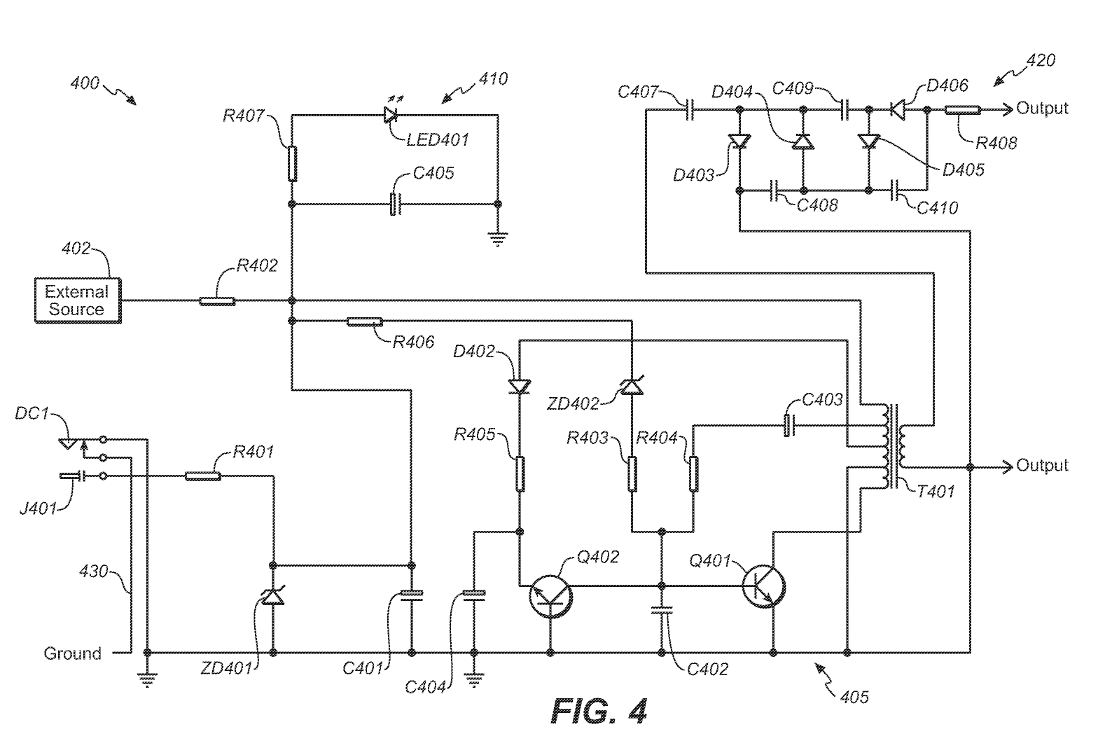

Referring now to FIG. 4, there is shown an alternative schematic of a preferred embodiment of the electronic circuit for converting low voltage DC into high voltage pulses for creating a coronal discharge that ionizes nearby air molecules. In FIG. 4 it can be seen that either a photovoltaic power source or a standard 120/240 VAC to 3 VDC-6 VDC wall adapter can connected to power input jack of the circuit.

Here, input jack J301 passes the low voltage DC 401 to the input DCI of the circuit. The low voltage DC is converted into high voltage and pulsed as follows: via protection diode D401 and current limiting resistor R401. Low voltage input is also from solar array 402 and passes through current limiting resistor R402.

Voltage regulation is provided by Zener diode ZD401 and capacitor C401.

Pulse oscillator circuit 405 comprises transistors Q401, Q402, diode D402, Zener diode ZD402, resistors R403, R404, R405, and R406, capacitors C402, C403, and C404, and primary transformer T401.

External Flashing LED circuit 410 includes LED401, capacitor C405 and resistor R407.

Four stage high voltage multiplier circuit 420 includes capacitors C407, C408, C409 and C410, HV diodes D403, D404, D405, and D406 and output limiting resistor R408.

Pulse repetition frequency may be varied by adjusting value of R406 and by varying level of input voltage source.

The external LED LED401 will flash at a rate consistent with pulse repetition frequency and serve as an aid to the user to optimize the location of the device for maximum exposure to the light source.

High voltage output consists of a limited pulse train having peak voltage levels of −4 KV to −9 KV instead of a constant DC output to effect enough voltage to ionize air molecules while using a minimum of input current to the circuit (typically less than 10 ma).

When not using a 5 VDC wall adapter as a voltage source and using only the solar array as the primary voltage source a single conductor 55 cm long stainless steel 28-30 ga stranded wire is connected through the power jack to extend the circuit ground plane of the circuit traces to the external environmental atmosphere of the ion generating circuit.

For indoor use, the air ionizer generally requires an AC wall adapter. When connected it disengages the solar panel and serves as the power source for the unit. When using AC current, the flashing green LED light on the side of the unit turns on. Placement of the unit above the plants being treated indoors is the same as in outdoor applications.

Ion concentrations delivered to the treated plants will vary depending upon ambient conditions. To be effective, the unit is designed to deliver a minimum of 3,500 ions per cubic centimeter per second to the plant area. This is a quantity consistent with what is believed to be the optimal “natural” environment for plant life. The unit is capable of producing in excess of 3,500,000 ions per second. Many of the produced ions will be lost due to air currents, distance from the plants, and moisture conditions. This is anticipated in the design and will not harm the plants at the higher levels while still providing the minimum quantity needed in the treated area even under diluted conditions. In an outdoor installation, no ions will be produced in darkness, and very little will be produced during rainy conditions. This is also perfectly normal. The goal is to produce the maximum amount of ions for the plant during peak sunlight hours, which are also the peak times for photosynthesis.

Maintenance of air ionizer is minimal, required only to keep the unit solar array clean so as to allow as much sunlight as possible to strike the solar cells. The emitter wire located at the very bottom of the unit may also require periodic cleaning, but only after several months of operation. To accomplish this, a user simply observes if a white speck of material resembling a grain of salt is forming at the tip of the wire element (the white speck is actually bonding material extruded from the tungsten wire). It may be removed by gently tapping it away with a toothpick any other insulated material.

It will be appreciated that unit longevity can be enhanced by encapsulating the electronic components so as to protect them from humidity, corrosive chemicals, mechanical shock, large temperature variations causing thermal expansion and contraction, and other harsh ambient conditions, as well as high voltages from the system itself. Such encapsulation can be accomplished using any of a number of potting and encapsulation systems, including potting in polymeric compounds such as epoxies, silicones, polyurethanes, or UV curable systems.

Unit position around the plants being treated is maintained to absorb the maximum amount of sunlight while operating outdoors. Guarding against plant foliage growing aggressively towards the emitter and coming into physical contact with the emitter is also essential, inasmuch as it is quite normal for the plants to grow faster in the direction of the ion source (emitter), and some diligence must be exercised to rearrange plant foliage and/or unit location to avoid this occurrence.

Walls in close proximity to plants being treated indoors may exhibit discoloring after several months of operation. This is due to the natural tendency of the ions to clean the air in the immediate vicinity through a process of electrostatic precipitation. It is recommended that plants be located several feet away from walls to avoid this “dirty wall” effect.”

Thus, it is seen from the foregoing that in its most essential aspect, the present invention is an air ionizer for enhancing plant growth that includes: a housing; an electric power supply to provide low voltage direct current; a power converter circuit enclosed in said housing that converts the low voltage direct current provided by said power supply to pulsed high voltage or high voltage DC power; and an ion emitter tip coupled to said power converter circuit and extending from said housing; wherein said pulsed high voltage or high voltage direct current from said power converter circuit is routed to said ion emitter element to produce ionized atmospheric gases in proximity to said housing, such that a nearby plant may take up the charged gases as part of its respiration and metabolic cycles.

The foregoing disclosure is sufficient to enable those with skill in the relevant art to practice the invention without undue experimentation. The disclosure further provides the best mode of practicing the invention now contemplated by the inventor.

What is claimed as invention is:

1. An air ionizing apparatus for enhancing plant growth, comprising:
a housing;
an electrical power source;
a voltage regulator/conditioner circuit electrically coupled to said electrical power source and disposed in said housing;
an oscillator/modulator circuit disposed in said housing and electrically coupled to said voltage regulator/conditioner circuit;
a high voltage converter/multiplier circuit disposed in said housing and electrically coupled to said oscillator/modulator circuit; and
an ion emitter element electrically coupled to said high/voltage converter/multiplier circuit, said ion emitter element having a tip exposed through a bottom of said housing;
wherein electrical power from said electrical power source is converted to high voltage through said voltage/regulator, said oscillator/modulator, and said high voltage converter/multiplier circuits, the high voltage then being applied to said ion emitter element to produce ions from ambient air.

2. The apparatus of claim 1, where said electrical power source comprises a photovoltaic array including a plurality of solar cells mounted atop said housing for optimal exposure to sunlight.

3. The apparatus of claim 2, wherein said photovoltaic array is connected to a common ground, and further including a small gauge external wire tendril connected to said common ground and dangling on the outside of said housing for exposure to the atmosphere.

4. The apparatus of claim 1, wherein atmospheric ions produced are negative ions.

5. The apparatus of claim 1, wherein the atmospheric ions produced are positive ions.

6. The apparatus of claim 1, wherein the atmospheric ions produced include both positive and negative ions.

7. The apparatus of claim 1, wherein said apparatus imparts to a treated plant a voltage charge sufficient to discourage habitation by unwanted herbivores.

8. The apparatus of claim 1, wherein output high voltage automatically drops to a safe (non-shocking) level when said ion emitter element contacts any low impedance physical object or person.

9. The apparatus of claim 1, wherein radiated output voltage and power level is maintained below that which may cause radio frequency interference.

10. The apparatus of claim 1, further including encapsulation protecting electronic circuit components from ambient conditions.

11. The apparatus of claim 1, wherein the intensity and frequency of flashing LED power indicator varies in direct proportion to input voltage supplied by said solar array or said wall adapter.

12. A method of enhancing and accelerating plant metabolism and growth, comprising the step of positioning and operating an air ionizing apparatus in close proximity to a plant so as to expose the plant to ions produced in the air proximate the plant.

13. The method of claim 12, wherein the air ionizing apparatus includes a housing, an electrical power source, a voltage regulator/conditioner circuit electrically coupled to the electrical power source and disposed in the housing, an oscillator/modulator circuit disposed in the housing and electrically coupled to the voltage regulator/conditioner circuit, a high voltage converter/multiplier circuit disposed in the housing and electrically coupled to the oscillator/modulator circuit, and an ion emitter element electrically coupled to the high/voltage converter/multiplier circuit, the ion emitter element having a tip exposed through the housing, such that the electrical power from the electrical power source is converted to high voltage through the voltage/regulator, the oscillator/modulator, and the high voltage converter/multiplier circuits, and the high voltage is then applied to the ion emitter element to produce ions in a portion of the air proximate the plant.

14. The method of claim 13, wherein the electrical power source comprises a plurality of solar cells mounted on a top side of the housing.

15. The method of claim 14, wherein the air ionizing apparatus produces more ions as solar radiation increases.

16. The method of claim 12, wherein the air ionizing produces primarily negative ions.

17. The method of claim 12, wherein the air ionizing apparatus produces primarily positive ions.

18. The method of claim 12, wherein the air ionizing apparatus produces both positive and negative ions.

19. The method of claim 12, further including the step of using the air ionizing apparatus to create a voltage charge sufficient to discourage herbivores from inhabiting and eating the plant.

20. An air ionizer for enhancing plant growth, comprising:
a housing;
an electric power supply to provide low voltage direct current;
a power converter circuit enclosed in said housing that converts the low voltage direct current provided by said power supply to pulsed high voltage or high voltage DC power; and
an ion emitter tip coupled to said power converter circuit and extending from said housing;
wherein said pulsed high voltage or high voltage direct current from said power converter circuit is routed to said ion emitter element to produce ionized atmospheric gases in proximity to said housing, such that a nearby plant may take up the charged gases as part of its respiration and metabolic cycles.
